(19) United States
(12) Patent Application Publication
(10) Pub. No.: US 2014/0134437 A1
(43) Pub. Date: May 15, 2014

(54) SINGLE CRYSTAL LUMINOPHOR MATERIAL FOR WHITE LIGHT-EMITTING DIODES

(71) Applicants: Mikhail Alexandrovich Arkhipov, Alexandrov (RU); Mukhamed Magomedovich Arsanukaev, Alexandrov (RU); Sergey Stepanovich Kovalev, Alexandrov (RU); Sofia Alexandrovna Smirnova, Alexandrov (RU); Vladimir Fedorovich Shitsle, Alexandrov (RU)

(72) Inventors: Mikhail Alexandrovich Arkhipov, Alexandrov (RU); Mukhamed Magomedovich Arsanukaev, Alexandrov (RU); Sergey Stepanovich Kovalev, Alexandrov (RU); Sofia Alexandrovna Smirnova, Alexandrov (RU); Vladimir Fedorovich Shitsle, Alexandrov (RU)

(21) Appl. No.: 14/035,983

(22) Filed: Sep. 25, 2013

Related U.S. Application Data
(60) Provisional application No. 61/725,034, filed on Nov. 12, 2012.

(51) Int. Cl. C09K 11/77

(52) U.S. Cl. CPC C09K 11/7774
USPC 428/402; 252/301.4 R

(57) ABSTRACT

The invention relates to a single crystal luminophor material for white light-emitting diodes, which is a solid solution of aluminum oxide (Al₂O₃) and yttrium aluminum garnet activated with cerium (Y₃Al₅O₁₂:Ce) and/or rare earth elements—samarium, gadolinium, lutetium, dysprosium, and terbium.

The present invention relates to a luminophor material which has the ability to luminesce when exposed to different sources of light radiation, such as complex nitride crystals, mercury lamps, etc.

### PRIOR ART

Luminophors for white light-emitting diodes having a composition of yttrium-aluminum garnet where a luminescent element is cerium (YAG:Ce) are widely known. These luminophors may be realized in a form of epitaxial films on substrates made of various materials, powders with subtle crystal structure produced by different methods, and transparent ceramics. Numerous technical solutions in this field are mainly aimed at increasing the cerium emission by the increasing its concentration in the matrix and/or by the additional introduction of other elements to YAG composition.

The substitute elements are introduced not only in yttrium, but also in aluminum sublattice of garnet. With all the variety of proposed compositions the ratio of the components corresponds to the stoichiometric formula of garnet, i.e. A₃B₅O₁₂. For example the U.S. Pat. No. 6,409,938B1 proposes Y, Ce, Gd Lu, as component A and Al, Ga, Sc, In as component B.

According to the U.S. Pat. No. 6,552,487B1 the luminophor material additionally contains Pr.

In the U.S. Pat. Nos. 6,998,771B2, 7,132,786B1, and 7,261,837B2 the luminophors with garnet structure with a partial or complete replacement of the Y on Tb are declared. The introduction of these elements into the garnet structure causes a shift of emission maximum to the some part of the spectrum. In turn, it leads to a change in chromaticity coordinates, light saturation, and total intensity.

Changing the composition and structure of the matrix makes it possible to create a white light emitting diode, where the several luminophors are used (U.S. Pat. No. 7,038,370 B3).

It should be also noted that luminophors based on films and powders may stably operate only within fairly narrow temperature range and environmental conditions and have limitations on the service time—source luminous flux may drop by half after a few thousand hours of work. Besides, such luminophors are very difficult and expense to produce.

### BRIEF DESCRIPTION OF DRAWINGS

FIG. 1 shows the diagram of photoluminescence intensity of YAG: Ce of stoichiometric compound corresponding to the formula (Y_{0.993}Ce_{0.007})₃Al₅O₁₂.

FIG. 2 shows the diagram of luminescence peak of the solid solution with the same concentration of cerium as in the stoichiometric YAG corresponding to the formula (Y_{0.993}Ce_{0.007})₃Al₈O₁₆.

FIG. 3 shows the diagram of luminescence intensity of the solid solution with dysprosium of (Y_{0.993}Ce_{0.007}Dy_{0.150})₃Al_{5.17}O_{12.25} compound.

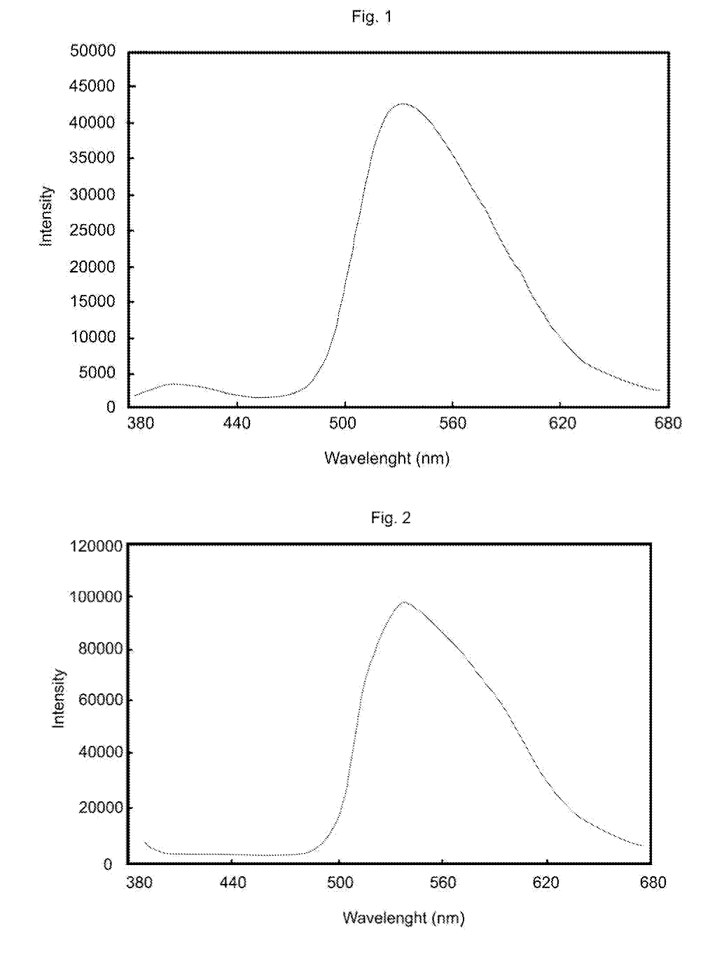

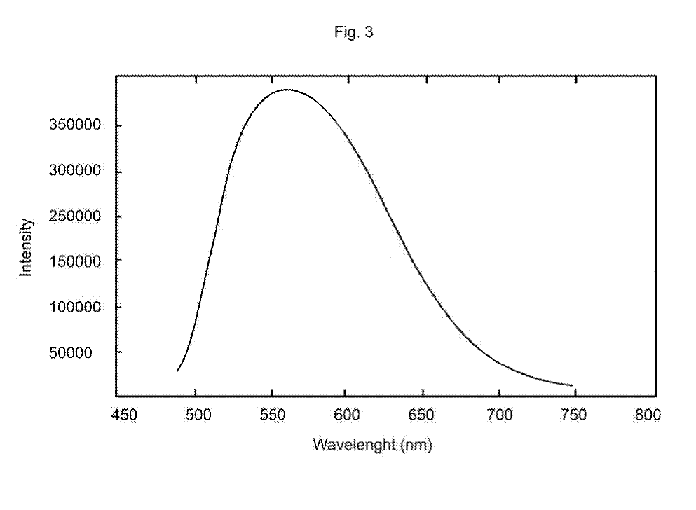

### DETAILED DESCRIPTION

The main technical object of the invention is to increase the intensity of luminophor material photoluminescence in combination with a high functional performance under the different environmental conditions.

The above technical problem is solved by producing a luminophor material for white light-emitting diodes as a solid solution of aluminum oxide (Al₂O₃) and yttrium—aluminum garnet with cerium (Y₃Al₅O₁₂:Ce), and/or Sm, Gd, Lu.

The advantage of the proposed invention is that the phosphor material is a solid solution, which has a compound corresponding to the formula:

(Y_{1-a-b-c-d}CeₐSm_{b}Gd_{c}Lu_{d})₃Al₅₊ₓO_{12+1.5x},

where a=0.007-0.020; b=0.00-0.03; c=0.00-0.99; d=0.00-0.99; x=0.17-3.97.

The main contribution to the photoluminescence intensity increase is made by the super-stoichiometric composition of aluminum oxide within the solid solution. It is due to the fact that the enhanced concentration of Al₂O₃ leads to the formation of cerium-containing aluminum clusters in melt. It leads to the cerium coefficient concentration increase and to the uniformity of its distribution in the solid solution crystal matrix.

The inclusion of dysprosium (Dy) and/or terbium (Tb) besides known Sm, Gd, Lu into the solid solution composition leads to the intense increase in its photoluminescence. It is due to the fact that the Dy³⁺ and Tb³⁺ ions introduced to the dodecahedral sublattice of YAG:Ce not only shift the emission maximum to the long-wavelength area (region) of the spectrum like Sm, Gd and Lu, but also have a sensitizing effect on the Ce³⁺ ion by resonance energy transfer from their emitting levels to the 2D3/2 level of the Ce³ ion.

In this case, the composition of the luminophor material corresponds to the formula:

(Y_{1-a-b-c-d}CeₐSm_{b}Gd_{c}Lu_{d}DyₑTb_{f})₃Al₅₊ₓO_{12+1.5x},

where a=0.007-0.020; b=0.00-0.03; c=0.00-0.99; d=0.00-0.99; x=0.17-3.97; e=0.00-0.15; f=0.00-0.15.

The use of the proposed luminophor material for white light-emitting diodes allows to increase the photoluminescence intensity in 2-3 times combined with its high stability in a different climate conditions. It can significantly widen the field of application of white light-emitting diodes.

Said luminophor material may be realized if a form of plane-parallel plate with ground or polished surfaces or in a form of single-crystal grain of 5-150 microns in size.

What is claimed is:

1. Single crystal luminophor material for white light-emitting diodes comprising a solid solution of aluminum oxide and yttrium—aluminum garnet with a composition thereof corresponding to the following formula:
(Y_{1-a-b-c-d}CeₐSm_{b}Gd_{c}Lu_{d})₃Al₅₊ₓO_{12+1.5x}.

2. Single crystal luminophor material as recited in claim 1, where a is within the span 0.007-0.020.

3. Single crystal luminophor material as recited in claim 1, where b is within the span 0.00-0.03.

4. Single crystal luminophor material as recited in claim 1, where c is within the span 0.00-0.99.

5. Single crystal luminophor material as recited in claim 1, where d is within the span 0.00-0.99.

6. Single crystal luminophor material as recited in claim 1, where x is within the span 0.17-3.97.

7. Single crystal luminophor material for white light-emitting diodes with a composition thereof corresponding to the following formula:
(Y_{1-a-b-c-d}CeₐSm_{b}Gd_{c}Lu_{d}DyₑTb_{f})₃Al₅₊ₓO_{12+1.5x}.

8. Single crystal luminophor material as recited in claim 7, where a is within the span 0.007-0.020.

9. Single crystal luminophor material as recited in claim 7, where b is within the span 0.00-0.03.

10. Single crystal luminophor material as recited in claim 7, where c is within the span 0.00-0.99.

11. Single crystal luminophor material as recited in claim 7, where d is within the span 0.00-0.99.

12. Single crystal luminophor material as recited in claim 7, where x is within the span 0.17-3.97.

13. Single crystal luminophor material as recited in claim 7, where e is within the span 0.0-0.15.

14. Single crystal luminophor material as recited in claim 7, where f is within the span 0.0-0.15.

15. Workpiece for white light-emitting diodes made of single crystal luminophor material as recited in claims 1 or 7.

16. Workpiece as recited in claim 15, realized in a form of plane-parallel plate with ground or polished surfaces.

17. Workpiece as recited in claim 15 realized in a form of plurality of single-crystal grains.

18. Workpiece as recited in claim 17 wherein said single-crystal grains are 5-150 microns in size.
